(19) United States
(12) Patent Application Publication
(10) Pub. No.: US 2026/0092001 A1
(43) Pub. Date: Apr. 2, 2026

(54) PET DRINKING DEVICE

(71) Applicant: DO-IT INNOVATIONS TECHNOLOGY CO.,LTD., ZHUHAI (CN)

(72) Inventors: JIACHENG HUANG, ZHUHAI (CN); SHAOCHUN TIAN, ZHUHAI (CN)

(21) Appl. No.: 18/915,835

(22) Filed: Oct. 15, 2024

(30) Foreign Application Priority Data
Sep. 30, 2024 (CN) 202422407852.4

(51) Int. Cl. C02F 9/20; A01K 7/02; C02F 1/00; C02F 1/32; C02F 1/467; C02F 1/50; C02F 1/78; C02F 101/20

(52) U.S. Cl. CPC C02F 9/20; A01K 7/02; C02F 1/003; C02F 1/325; C02F 1/4672; C02F 1/50; C02F 1/78; C02F 2101/20; C02F 2303/02; C02F 2303/04; C02F 2303/22

(57) ABSTRACT

A pet drinking device includes a water tank including a water storage chamber for storing water and a drinking water trough for pets to drink water; a circuit board arranged on the water tank; a water pumping mechanism electrically connected to the circuit board, the water pumping mechanism arranged in the water storage chamber and configured to circulate water in the water storage chamber and the drinking water trough when the circuit board is driven; and a filter element assembly. The filter element assembly includes a softened water quality filter element for softening water quality, a heavy metal filter element for filtering heavy metals and an antibacterial and deodorizing filter element for removing peculiar smell, the softened water quality filter element, the heavy metal filter element and the antibacterial and deodorizing filter element are arranged on the water tank for filtering water during water circulation.

### CROSS-REFERENCE TO RELATED APPLICATIONS

The application claims priority of Chinese patent application CN2024224078524, filed on 2024 Sep. 30, which is incorporated herein by reference in its entireties.

### TECHNICAL FIELD

The present invention relates to the technical field of pet products, in particular to a pet drinking device.

### BACKGROUND

With the elevation of people's living standards, more and more families keep pets. In order to ensure the health of pet drinking water, pet water dispensers emerge as the times require. However, the existing pet water dispensers generally utilize ultraviolet rays for sterilizing the water consumed by pets. Nevertheless, the range of ultraviolet irradiation is restricted, and the penetrability of ultraviolet rays is feeble and incapable of penetrating thicker substances. Consequently, ultraviolet rays can merely sterilize the water within the directly irradiated zone. Regarding the shaded portions of objects, occluded areas, or the interiors of objects with complex shapes, it is arduous to attain a sterilization effect. Additionally, ultraviolet rays are readily influenced by factors like dust and humidity in the environment, leading to a decline in the sterilization efficacy of ultraviolet rays and falling short of meeting the users' requirements.

### SUMMARY

The main purpose of the present disclosure is to provide a pet drinking device to solve the problem that the existing pet water dispensers using ultraviolet rays to sterilize and disinfect water have unsatisfactory effects.

A pet drinking device includes a water tank including a water storage chamber for storing water and a drinking water trough for pets to drink water; a circuit board arranged on the water tank; a water pumping mechanism electrically connected to the circuit board, the water pumping mechanism arranged on the water tank and configured to circulate water in the water storage chamber and the drinking water trough when being opened; and an electrolysis module electrically connected to the circuit board, wherein when the electrolysis module is driven, the electrolysis module generates active substances for sterilization and disinfection, and the electrolysis module is configured to generate active substances for sterilization and disinfection during a circulation of water and when being driven.

Further, the water tank is provided with a drinking water outlet and a backwater channel respectively connected to the drinking water trough; the electrolysis module includes an electrolysis housing with an electrolysis chamber, and an anode device and a cathode device arranged in the electrolysis chamber, the anode device and the cathode device are respectively electrically connected to the circuit board, the electrolysis housing is provided with an electrolysis water inlet and an electrolysis water outlet respectively connected to the electrolysis chamber, the electrolysis water outlet is connected to the drinking water outlet, each of two ends of the backwater channel is respectively connected to the drinking water trough and the water storage chamber, a water inlet of the water pumping mechanism is connected to the water storage chamber, and a water outlet of the water pumping mechanism is connected to the electrolysis water inlet.

Further, the electrolysis module further includes an insulating member arranged in the electrolysis chamber, and the insulating member is positioned between the anode device and the cathode device.

Further, the electrolysis module further includes a first conductive plate and a second conductive plate respectively electrically connected to the circuit board, one end of the first conductive plate is positioned in the electrolysis chamber and is electrically connected to the anode device, and one end of the second conductive plate is positioned in the electrolysis chamber and is electrically connected to the cathode device.

Further, the electrolysis housing includes an electrolysis surface housing and an electrolysis bottom housing, the electrolysis chamber is formed by the electrolysis surface housing and the electrolysis bottom housing, and the electrolysis water inlet and the electrolysis water outlet are arranged on the electrolysis surface housing.

Further, the pet drinking device further includes a filter element assembly arranged on the water tank, and the filter element assembly is configured to filter water during the circulation of water.

Further, the water tank is provided with a filter element housing on the backwater channel; the backwater channel includes a water return port arranged on the water tank and positioned on a sidewall of the drinking water trough, at least three accommodating chambers communicating each other and arranged along the circulating water direction in the filter element housing, and a filter element water inlet and a filter element water outlet arranged on the filter element housing; the water return port is connected to the filter element water inlet, each of two sides of the filter element water inlet is respectively connected to the accommodating chamber and the backwater channel positioned on one side, and each of two sides of the filter element water outlet is respectively connected to the accommodating chamber and the water storage chamber positioned on the other side; the filter element assembly includes a softened water quality filter element for softening water quality, a heavy metal filter element for filtering heavy metals and an antibacterial and deodorizing filter element for removing peculiar smell, and the antibacterial and deodorizing filter element, the softened water quality filter element, and the heavy metal filter element are respectively installed in one accommodating chamber.

Further, a height of a bottom surface of the accommodating chamber on one side adjacent to the filter element water inlet is higher than a height of the bottom surface of the accommodating chamber on one side adjacent to the filter element water outlet.

Further, the backwater channel further includes a buffer channel arranged on a top of the filter element housing, each of two sides of the buffer channel is respectively connected to the water return port and the filter element water inlet, and the buffer channel is obliquely arranged downwards along the direction adjacent to the filter element water inlet.

Further, a partition plate is arranged between each two adjacent accommodating chambers of the at least three accommodating chambers, the backwater channel further includes a first water passage arranged on the filter element housing, a first water passage opening arranged on a top of the partition plate close to one side of the filter element water inlet, and a second water passage opening arranged on a bottom of the partition plate close to one side the filter element water outlet; the buffer channel is connected to the filter element water inlet through the first water passage, the filter element water inlet is arranged close to a bottom of the accommodating chamber, the first water passage opening is connected to the filter element water inlet through the accommodating chamber, and the second water passage opening is connected to the filter element water outlet through the accommodating chamber.

Further, the backwater channel further includes a second water passage arranged on the water tank, the second water passage is positioned on the filter element housing, and each of two sides of the second water passage is respectively connected to the buffer channel and the water return port.

Further, the filter element housing includes a filter element surface housing and a filter element bottom housing, the filter element surface housing is connected to the filter element bottom housing form the accommodating chamber, the first water passage and the filter element water inlet, the buffer channel is arranged on a top portion of the filter element surface housing, the partition plate is arranged on the filter element surface housing, and the filter element water outlet is arranged on the filter element bottom housing.

Further, a water flow trough is further arranged on a top portion of the water tank, the water flow trough is connected to the drinking water trough, a height of one end of the water flow trough connected to the drinking water trough is lower than a height of one end of the water flow trough far away from the drinking water trough, and the drinking water outlet is arranged on a bottom surface of the water flow trough and is positioned at the end of the water flow trough far away from the drinking water trough.

Further, the water tank includes a main body bottom housing and an upper main body detachably connected to the main body bottom housing, the water storage chamber is formed by connecting the upper main body and the main body bottom housing, the drinking water outlet, the water return port, the water pumping mechanism, the filter element housing and the circuit board are arranged on the upper main body, and the filter element housing is detachably arranged on the upper main body.

Further, a storage groove for accommodating the filter element housing is provided at a bottom of the upper main body, a supporting block protrudes from a side wall of the upper main body corresponding to the storage groove, a butting block configured in cooperation with the supporting block is provided on the filter element housing, and the butting block is positioned above the supporting block when the filter element housing is placed in the storage groove.

Further, the upper main body is provided with a battery electrically connected to the circuit board, the battery is a rechargeable battery, the upper main body is provided with a charging interface for external connection of a power supply, and the charging interface is electrically connected to the circuit board.

Further, the upper main body includes a middle housing and a main body surface housing connected to the middle housing to form a mounting chamber, the circuit board, the battery and the electrolysis module are arranged in the mounting chamber, the water storage chamber is formed by surrounding the middle housing and the main body bottom housing, and the main body bottom housing is detachably connected to the main body surface housing or the middle housing.

Further, the main body surface housing is provided with a functional operating part electrically connected to the circuit board, and the circuit board is configured to control working of the water pumping mechanism or adjust driving pow of the electrolysis module when a user operates the functional operating part.

Further, a wireless module configured to communicate with an external equipment is arranged in the mounting chamber, and the wireless module is electrically connected to the circuit board.

Further, a UV lamp connected to the circuit board is arranged on a bottom of the middle housing.

Beneficial effects of the present invention are as follows. The pet drinking water device is provided with the electrolysis module during the water circulation process. When the electrolysis module is activated, it generates active substances for sterilization and disinfection. These active substances are used to sterilize and disinfect the water in circulation, thereby realizing the sterilization and disinfection of the water and solving the problem of the poor sterilization effect of existing ultraviolet rays on water. It can effectively eliminate harmful microorganisms such as bacteria, viruses, and fungi in the circulating water, maintain the cleanliness and sanitation of the drinking water, and reduce the risk of pets falling ill due to drinking unclean water.

### BRIEF DESCRIPTION OF THE DRAWINGS

Implementations of the present invention will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present invention.

FIG. 1 is a 3D schematic diagram of a pet drinking device of the present invention;

FIG. 2 is a 3D schematic diagram of the pet drinking device from another view of the present invention;

FIG. 3 is a disassembly diagram of an upper main body and a main body bottom housing of the pet drinking device of the present invention;

FIG. 4 is a sectional diagram cut along a center line of the filter element assembly of the pet drinking device of the present invention;

FIG. 5 is a schematic diagram after removing the main body bottom housing of the pet drinking device of the present invention;

FIG. 6 is a disassembly diagram of the upper main body and a filter element housing of the pet drinking device of the present invention;

FIG. 7 is a 3D schematic diagram of the filter element housing of the pet drinking device of the present invention;

FIG. 8 is an exploded diagram of the filter element housing of the pet drinking device of the present invention;

FIG. 9 is a disassembly diagram after removing the main body bottom housing and a water pumping mechanism of the pet drinking device of the present invention;

FIG. 10 is a 3D schematic diagram of an electrolysis module of the pet drinking device of the present invention;

FIG. 11 is an exploded diagram of the electrolysis module of the pet drinking device of the present invention; and

FIG. 12 is an exploded diagram of the electrolysis module from another view of the pet drinking device of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

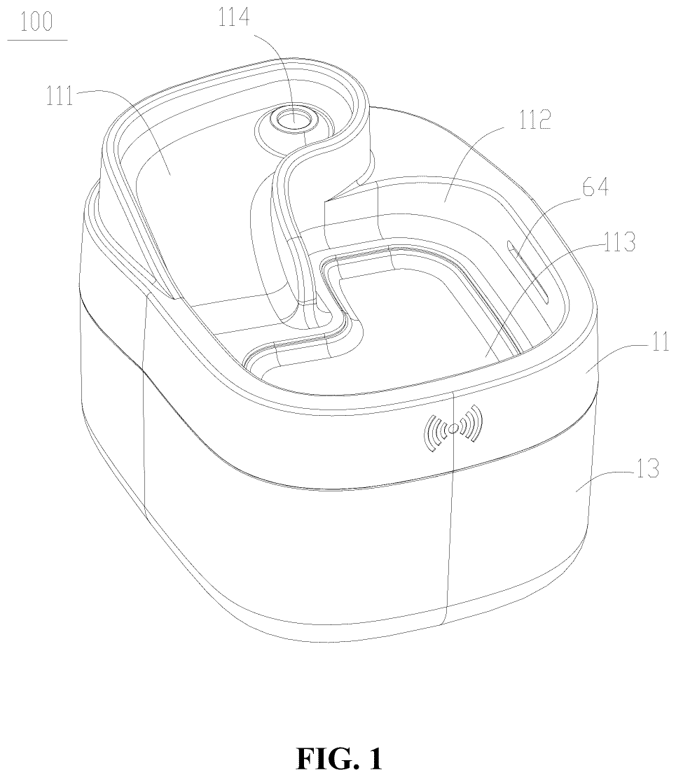

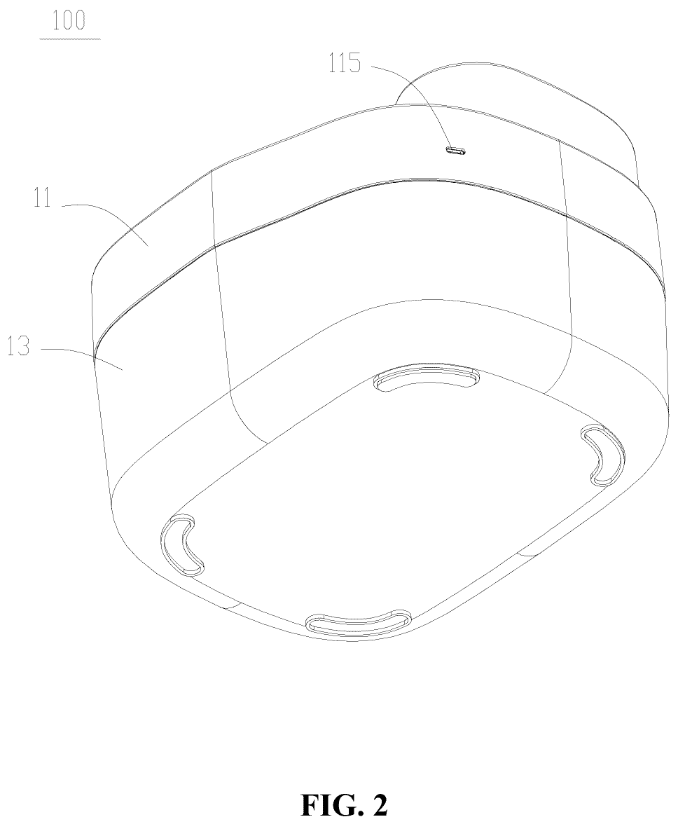

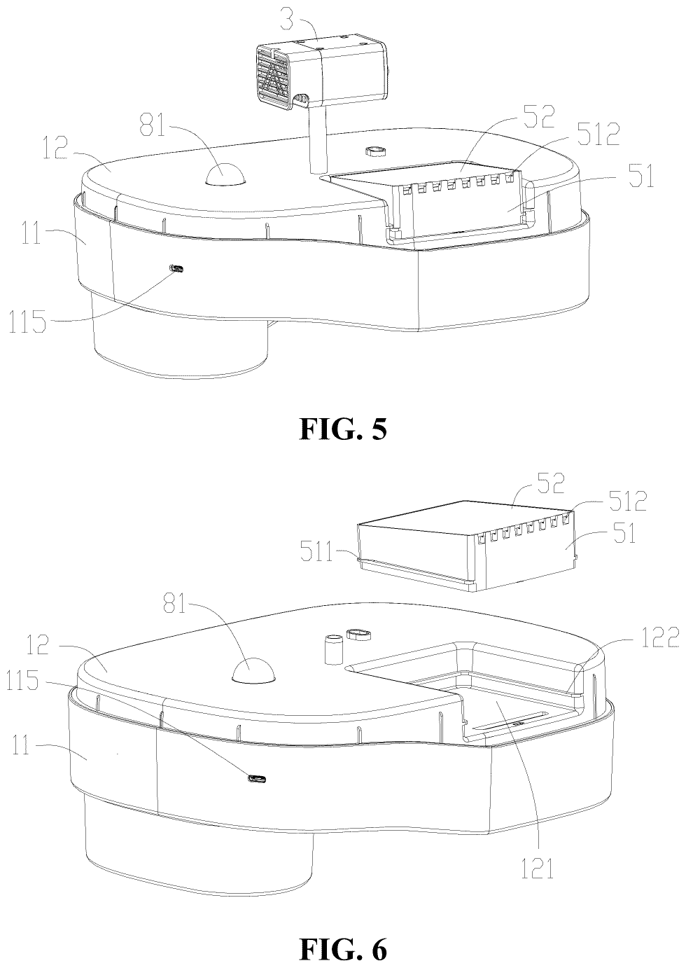

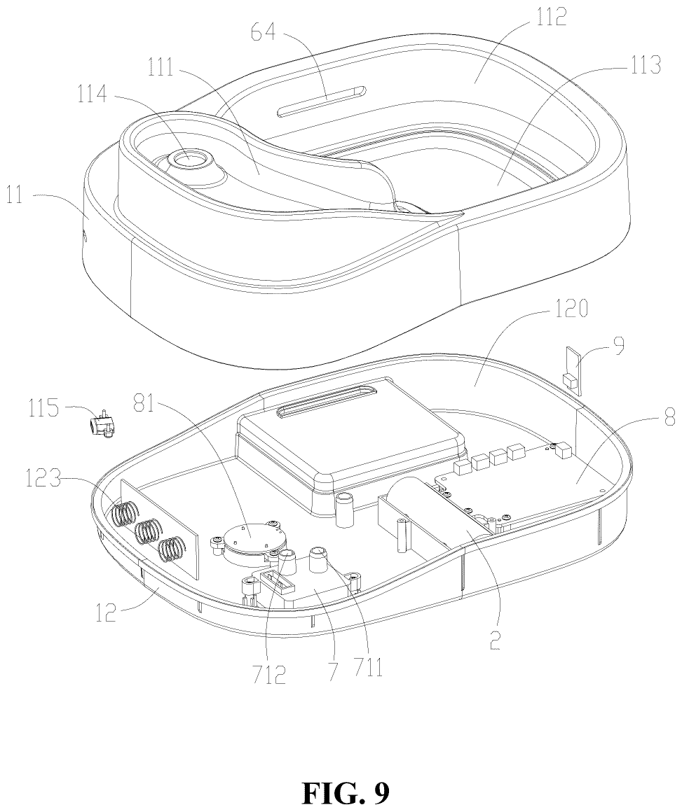

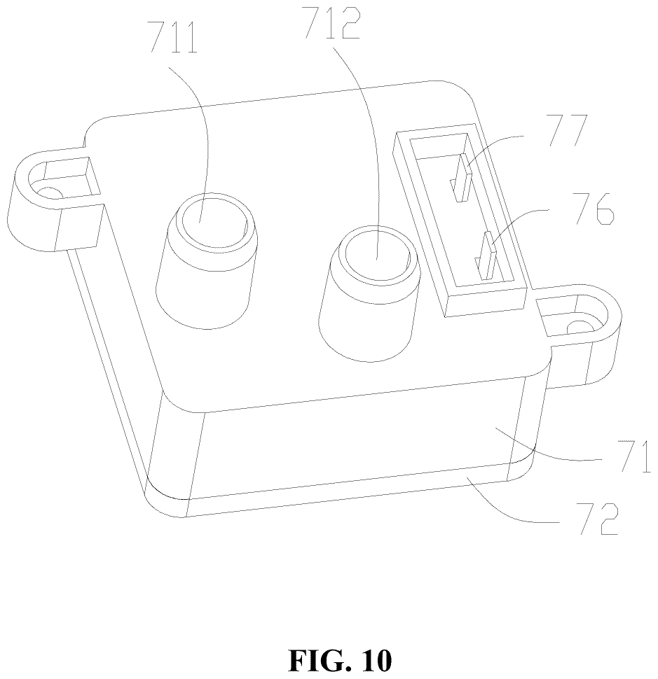

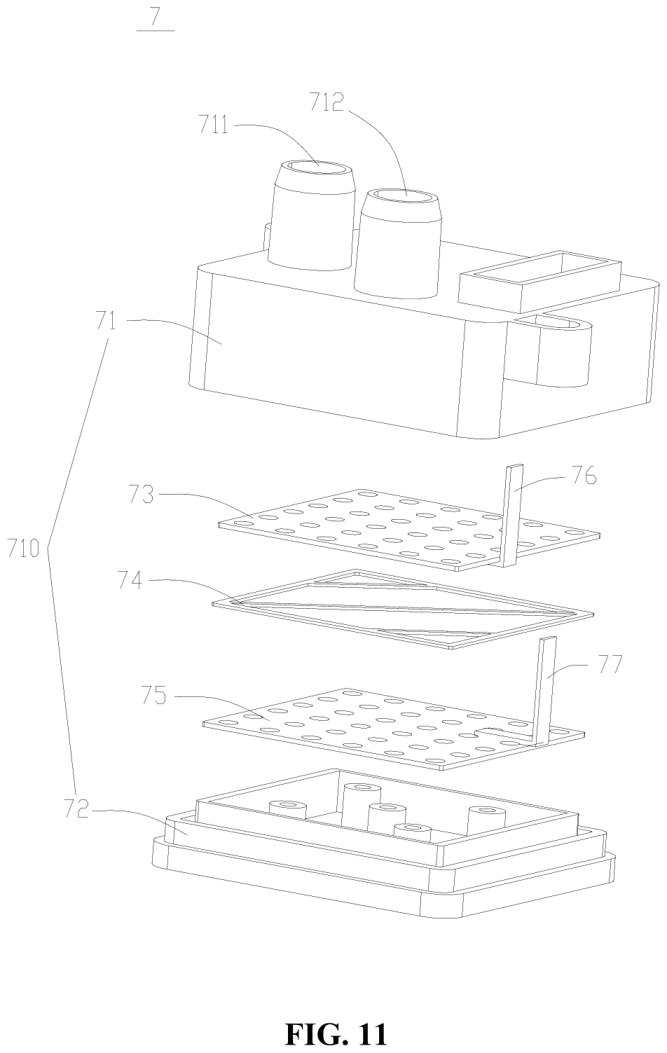

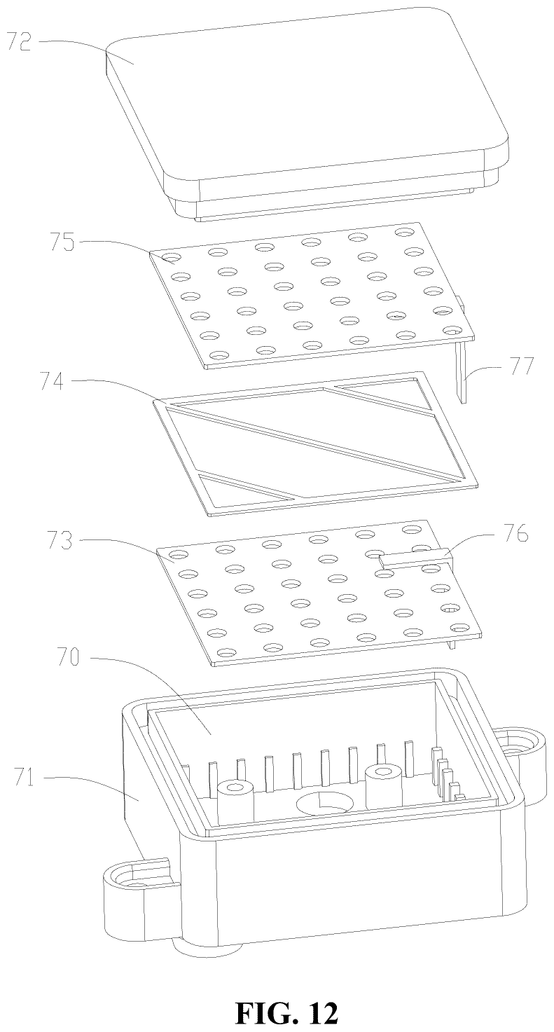

Referring to FIG. 1 to FIG. 5 and FIG. 9 to FIG. 12, a pet drinking device 100 includes a water tank 1, and the water tank 1 includes a water storage chamber 130 for storing water and a drinking water trough 112 for pets to drink water; a circuit board 8 arranged on the water tank 1; a water pumping mechanism 3 electrically connected to the circuit board 8, the water pumping mechanism 3 arranged on the water tank 1 and configured to circulate water in the water storage chamber 130 and the drinking water trough 112 when being opened; and an electrolysis module 7 electrically connected to the circuit board 8, when the electrolysis module 7 is driven, the electrolysis module generates active substances for sterilization and disinfection, and the electrolysis module 7 is configured to generate active substances for sterilization and disinfection during a circulation of water and when being driven.

In this embodiment, the pet drinking water device is provided with the electrolysis module 7 during the water circulation process. When the electrolysis module 7 is activated, it generates active substances for sterilization and disinfection. These active substances are used to sterilize and disinfect the water in circulation, thereby realizing the sterilization and disinfection of the water and solving the problem of the poor sterilization effect of existing ultraviolet rays on water. It can effectively eliminate harmful microorganisms such as bacteria, viruses, and fungi in the circulating water, maintain the cleanliness and sanitation of the drinking water, and reduce the risk of pets falling ill due to drinking unclean water.

In an embodiment, the water tank 1 is provided with a drinking water outlet 114 and a backwater channel 6 respectively connected to the drinking water trough 112. The electrolysis module 7 includes an electrolysis housing 710 with an electrolysis chamber 70, and an anode device 73 and a cathode device 75 arranged in the electrolysis chamber 70, the anode device 73 and the cathode device 75 are respectively electrically connected to the circuit board 8, the electrolysis housing 710 is provided with an electrolysis water inlet 711 and an electrolysis water outlet 712 respectively connected to the electrolysis chamber 70, the electrolysis water outlet 712 is connected to the drinking water outlet 114, each of two ends of the backwater channel 6 is respectively connected to the drinking water trough 112 and the water storage chamber 130, a water inlet of the water pumping mechanism 3 is connected to the water storage chamber 130, and a water outlet of the water pumping mechanism 3 is connected to the electrolysis water inlet 711.

Through arranging the backwater channel 6, when the water in the drinking water trough 112 reaches the backwater channel 6, the water in the drinking water trough 112 flows back to the water storage chamber 130 through the backwater channel 6. When the circuit board 8 drives the water pumping mechanism 3 to work, the water pumping mechanism 3 can discharge the water in the water tank 1 to the drinking water trough 112 sequentially through the water inlet of the water pumping mechanism 3, the water outlet of the water pumping mechanism 3, the electrolysis water inlet 711, the electrolysis chamber 70, and the electrolysis water outlet 712 from the drinking water outlet 114. By using the electrolysis housing 710 to form the electrolysis chamber 70 to accommodate the anode device 73 and the cathode device 75, and using the electrolysis chamber 70 to provide an accommodation space for the circulating water, so that when the anode device 73 and the cathode device 75 are driven by the circuit board 8, substances with disinfection and sterilization effects such as ozone will be generated. Moreover, ozone has strong oxidizability, which can effectively kill microorganisms such as bacteria, viruses and fungi in water, remove some harmful substances in water and improve water quality, thus reducing the risk of pet infection and ensuring the health of pet drinking water.

Specifically, in the above embodiment, the electrolysis module 7 preferably employs an electrolytic ozone generator of a low-voltage electrolysis method. Generally, the ozone generator does not produce toxic by-products. Moreover, it can also generate auxiliary components such as hydroxyl radicals and oxygen atoms with greater efficiency. Thus, the effects of sterilization, disinfection and water quality purification are more environmentally friendly and effective, and there is no harmful chemical residue after water treatment.

In an embodiment, the electrolysis module further includes an insulating member 74 arranged in the electrolysis chamber 70, and the insulating member 74 is positioned between the anode device 73 and the cathode device 75. By using the insulating member 74 to separate the anode device 73 from the cathode device 75, the anode device 73 can be prevented from contacting the cathode device 75. Moreover, the overall structure of the electrolysis module 7 can be made more compact and its overall volume can be reduced.

In an embodiment, the electrolysis module further includes a first conductive plate 76 and a second conductive plate 77 respectively electrically connected to the circuit board 8, one end of the first conductive plate 76 is positioned in the electrolysis chamber 70 and is electrically connected to the anode device 73, and one end of the second conductive plate 77 is positioned in the electrolysis chamber 70 and is electrically connected to the cathode device 75, so that the circuit board 8 is respectively electrically connected to the anode device 73 and the cathode device 75.

In an embodiment, to facilitate the manufacturing of the electrolysis housing 710, the electrolysis housing 710 includes an electrolysis surface housing 71 and an electrolysis bottom housing 72, the electrolysis chamber 70 is formed by the electrolysis surface housing 71 and the electrolysis bottom housing 72, and the electrolysis water inlet 711 and the electrolysis water outlet 712 are arranged on the electrolysis surface housing 71.

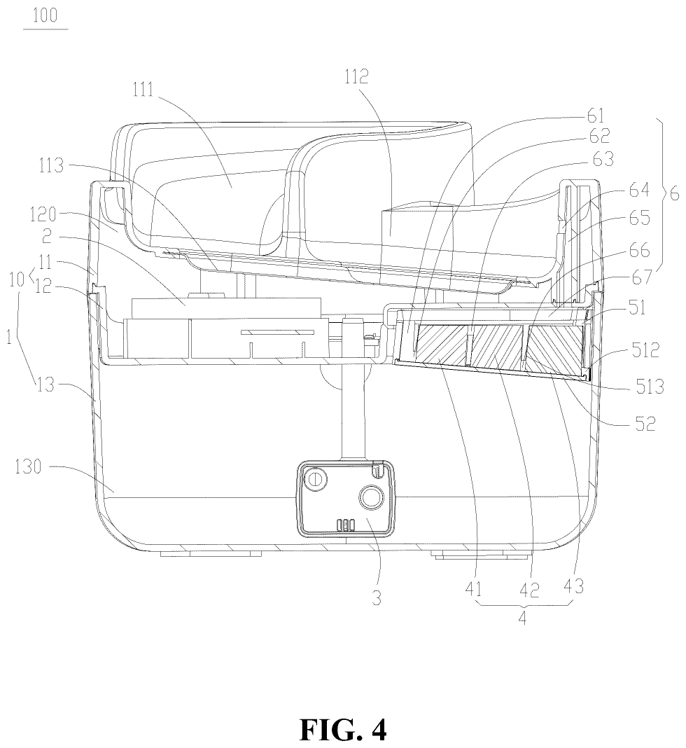

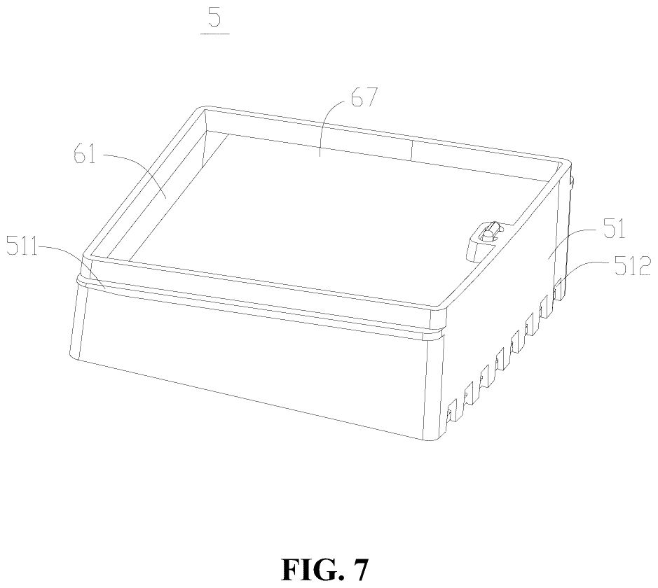

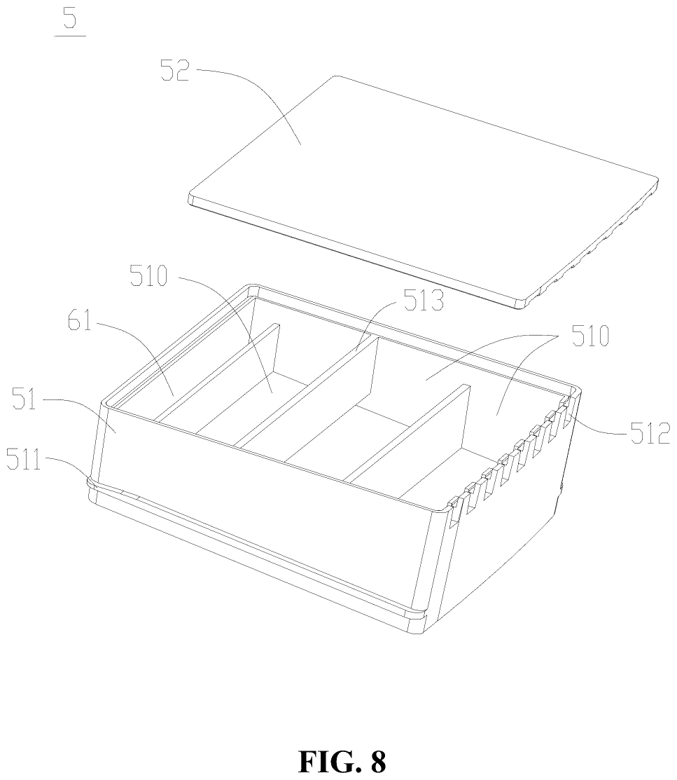

Referring to FIG. 4 to FIG. 8, in an embodiment, the pet drinking device 100 further includes a filter element assembly 4 arranged on the water tank 1. The filter element assembly 4 is configured to filter water during the circulation of water and is effectively in enhancing the drinking water for pets.

In an embodiment, the water tank 1 is provided with a filter element housing 5 on the backwater channel 6. The backwater channel 6 includes a water return port 64 arranged on the water tank 1 and positioned on a sidewall of the drinking water trough 112, at least three accommodating chambers 510 communicating each other and arranged along the circulating water direction in the filter element housing 5, and a filter element water inlet 62 and a filter element water outlet 512 arranged on the filter element housing 5. The water return port 64 is connected to the filter element water inlet 62, each of two sides of the filter element water inlet 62 is respectively connected to the accommodating chamber 510 and the backwater channel 6 positioned on one side, and each of two sides of the filter element water outlet 512 is respectively connected to the accommodating chamber 510 and the water storage chamber 130 positioned on the other side. The filter element assembly 4 includes a softened water quality filter element 42 for softening water quality, a heavy metal filter element 43 for filtering heavy metals and an antibacterial and deodorizing filter element 41 for removing peculiar smell, and the antibacterial and deodorizing filter element 41, the softened water quality filter element 42, and the heavy metal filter element 43 are respectively installed in one accommodating chamber 510.

Through arranging the filter element housing 5 on the backwater channel 6, the filter element assembly 4 can be installed in a limited position. The multiple accommodating chambers 510 arranged in sequence along the circulating water direction are used to respectively limit the filtration of the softened water quality filter element 42, the antibacterial and deodorizing filter element 41, and the heavy metal filter element 43. Thus, the circulating water can all be filtered through the softened water quality filter element 42, the antibacterial and deodorizing filter element 41, and the heavy metal filter element 43, so that each filter element can play a filtering role. This effectively removes impurities, odors, heavy metals in the circulating water and inhibits the growth of bacteria, effectively purifies the water quality, ensures the hygiene and safety of pet drinking water, and improves the drinking water quality for pets, which is conducive to the growth, development and health of pets.

In an embodiment, a material of the antibacterial and deodorizing filter element 41 includes nano mineral crystal elements. Among them, by using nano mineral crystal elements, the drinking water quality can be effectively improved, which is conducive to the growth, development and health of pets. In another embodiment, the antibacterial and deodorizing filter element 41 can also be activated carbon or the like.

In an embodiment, the antibacterial and deodorizing filter element 41, the softened water quality filter element 42, and the heavy metal filter element 43 are arranged in sequence in the direction adjacent to the filter element water outlet 512. In this way, the water flowing back from the water return port 64 first passes through the antibacterial and deodorizing filter element 41 for filtering to remove odors and inhibit the growth of microorganisms, then passes through the softened water quality filter element 42 to soften the water quality, and finally enters the water storage chamber 130 after the heavy metals are filtered out by the heavy metal filter element 43.

In an embodiment, a height of a bottom surface of the accommodating chamber 510 on one side adjacent to the filter element water inlet 62 is higher than a height of the bottom surface of the accommodating chamber 510 on one side adjacent to the filter element water outlet 512, enabling the water to flow smoothly from the filter element water inlet 62 to the filter element water outlet 512 and be discharged from the latter to the water storage chamber 130.

In an embodiment, the backwater channel 6 further includes a buffer channel 67 arranged on a top of the filter element housing 5, each of two sides of the buffer channel 67 is respectively connected to the water return port 64 and the filter element water inlet 62, and the buffer channel 67 is obliquely arranged downwards along the direction adjacent to the filter element water inlet 62. Through arranging the buffer channel 67, the flow path for the water in the drinking water trough 112 to flow back to the water storage chamber 130 can be increased. Moreover, by setting the buffer channel 67 in an inclined manner, after the water flowing out from the water return port 64 reaches the buffer channel 67, it flows obliquely to the filter element assembly 4, thus playing a role in buffering the water flow. This can effectively reduce the noise generated by the filter element when the water in the drinking water trough 112 directly falls from the water return port 64, serving as a noise reduction measure.

In an embodiment, a partition plate 513 is arranged between each two adjacent accommodating chambers 510 of the at least three accommodating chambers, the backwater channel 6 further includes a first water passage 61 arranged on the filter element housing 5, a first water passage opening 63 arranged on a top of the partition plate 513 close to one side of the filter element water inlet 62, and a second water passage opening 66 arranged on a bottom of the partition plate 513 close to one side the filter element water outlet 512. The buffer channel 67 is connected to the filter element water inlet 62 through the first water passage 61, the filter element water inlet 62 is arranged close to a bottom of the accommodating chamber 510, the first water passage opening 63 is connected to the filter element water inlet 62 through the accommodating chamber 510, and the second water passage opening 66 is connected to the filter element water outlet 512 through the accommodating chamber 510. By using the first water passage 61, the water in the buffer channel 67 can flow to the filter element water inlet 62 close to the bottom of the accommodating chamber 510. Moreover, by utilizing the opening positions of the first water passage opening 63 and the second water passage opening 66, the contact area between the circulating water and the antibacterial and deodorizing filter element 41, the softened water quality filter element 42, and the heavy metal filter element 43 can be effectively increased. This allows for full utilization of the antibacterial and deodorizing filter element 41, the softened water quality filter element 42, and the heavy metal filter element 43 to filter the water and improve the filtering effect.

In an embodiment, the backwater channel 6 further includes a second water passage 65 arranged on the water tank 1, the second water passage 65 is positioned on the filter element housing 5, and each of two sides of the second water passage 65 is respectively connected to the buffer channel 67 and the water return port 64. By using the second water passage 65, the water flowing out from the water return port 64 can be guided into the buffer channel 67.

In an embodiment, the filter element housing includes a filter element surface housing 51 and a filter element bottom housing 52, the filter element surface housing 51 is connected to the filter element bottom housing 52 form the accommodating chamber 510, the first water passage 61 and the filter element water inlet 62, the buffer channel 67 is arranged on a top portion of the filter element surface housing 51, the partition plate 513 is arranged on the filter element surface housing 51, and the filter element water outlet 512 is arranged on the filter element bottom housing 52. Dividing the filter element housing 5 into a filter element face housing 51 and a filter element bottom housing 52 can facilitate the production and manufacturing of the filter element assembly 4 and the installation of the antibacterial and deodorizing filter element 41, the softened water quality filter element 42, and the heavy metal filter element 43 in the accommodating chamber 510.

Referring to FIG. 1, in an embodiment, a water flow trough 111 is further arranged on a top portion of the water tank 1, the water flow trough 111 is connected to the drinking water trough 112, a height of one end of the water flow trough 111 connected to the drinking water trough 112 is lower than a height of one end of the water flow trough 111 far away from the drinking water trough 112, and the drinking water outlet 114 is arranged on a bottom surface of the water flow trough 111 and is positioned at the end of the water flow trough 111 far away from the drinking water trough 112. By using the water flow trough 111, the water coming out from the drinking water outlet 114 can flow into the drinking water trough 112 to form a flowing water source, so as to attract pets to drink more water. Moreover, allowing pets to directly drink the water treated by the antibacterial and deodorizing filter element 41, the softened water quality filter element 42, the heavy metal filter element 43 and the electrolysis module 7 can be beneficial to the healthy growth of pets.

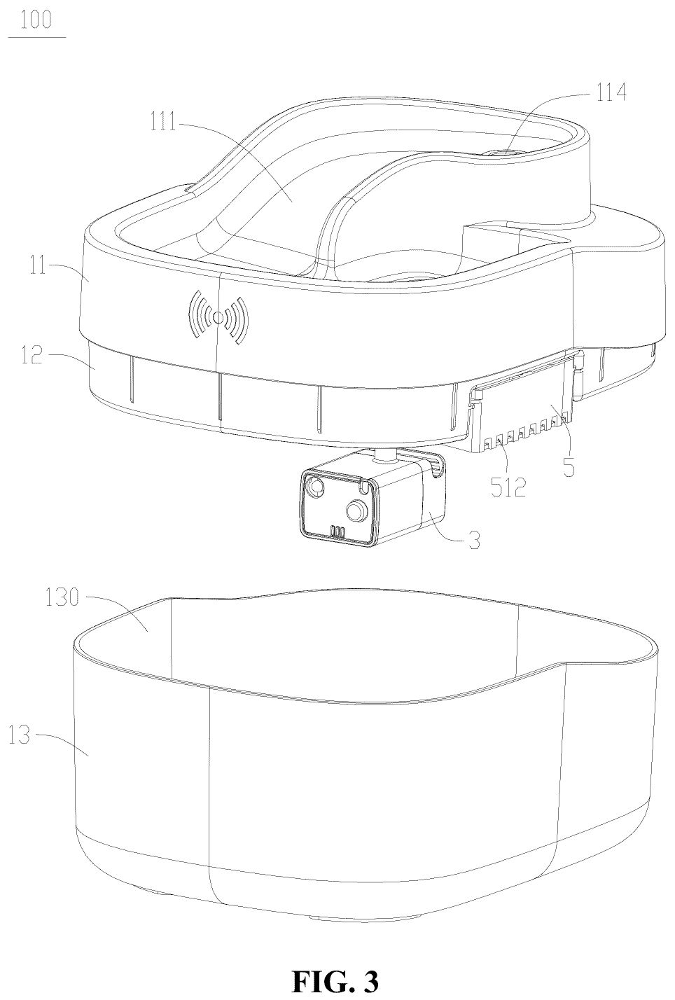

Referring to FIG. 3 to FIG. 6 and FIG. 9, in an embodiment, for the convenience of production and manufacturing of the pet drinking device 100 in this embodiment and the compactness of the structure, the water tank 1 includes a main body bottom housing 13 and an upper main body 10 detachably connected to the main body bottom housing 13, the water storage chamber 130 is formed by connecting the upper main body 10 and the main body bottom housing 13, the drinking water outlet 114, the water return port 64, the water pumping mechanism 3, the filter element housing 5 and the circuit board 8 are arranged on the upper main body 10.

In an embodiment, the filter element housing 5 is detachably arranged on the upper main body 10 so that the user can replace the filter element housing 5 and the filter element assembly 4, improve the service life of the pet drinking device 100 in this embodiment, and ensure the drinking water health of pets.

In an embodiment, a storage groove 121 for accommodating the filter element housing 5 is provided at a bottom of the upper main body 10, a supporting block 122 protrudes from a side wall of the upper main body 10 corresponding to the storage groove 121, a butting block configured in cooperation with the supporting block 122 is provided on the filter element housing 5, and the butting block is positioned above the supporting block 122 when the filter element housing 5 is placed in the storage groove 121. By using the supporting block 122 to support and abut against the abutting block, the filter element housing 5 is supported. Thus, the filter element housing 5 is arranged on the upper main body 10 in a drawer-like manner, so that the user can assemble the filter element housing 5 onto the upper main body 10 or disassemble it from the upper main body 10.

In an embodiment, the upper main body 10 is provided with a battery 2 electrically connected to the circuit board 8. By using the battery 2 to supply power to the circuit board 8, a power supply connected through a power line can be omitted, wiring is reduced, and convenience is brought to users.

In an embodiment, the battery 2 is a rechargeable battery, the upper main body 10 is provided with a charging interface 115 for external connection of a power supply, and the charging interface 115 is electrically connected to the circuit board 8. By connecting to the power supply through the power line adapted to the charging interface 115, the battery 2 can be charged through the circuit board 8.

In an embodiment, for the convenience of production and manufacturing of the upper main body 10 and the compactness of the structure, the upper main body 10 includes a middle housing 12 and a main body surface housing 11 connected to the middle housing 12 to form a mounting chamber 120, the circuit board 8, the battery 2 and the electrolysis module 7 are arranged in the mounting chamber 120, the water storage chamber 130 is formed by surrounding the middle housing 12 and the main body bottom housing 11, and the main body bottom housing 13 is detachably connected to the main body surface housing 11 or the middle housing 12. So that the main body bottom housing 13 can be detached conveniently, which is convenient for the user to clean the water tank 1 and add water, etc. The water pumping mechanism 3 is connected to the electrolysis water inlet 711 through a tube, and the tube passes through the middle housing 12 to prevent the middle housing 12 from affecting the inflow of water of the electrolysis water inlet 711.

In the above embodiment, the water pumping mechanism 3 is a water pump, the electrolysis water outlet 712 is connected to the drinking water outlet 114 through a tube, the second water passage 65, the water return port 64, the drinking water outlet 114, the water flow trough 111 and the drinking water trough 112 are arranged on the main body surface housing 11, the filter element housing 5 is detachably connected to the middle housing 12, the filter element housing 5 is positioned at a lower portion of the middle housing 12, and the second water passage 65 passes through the middle housing 12 and connects to the buffer channel 67, so that water flowing out of the water return port 64 enters the buffer channel 67 after passing through the second water passage 65.

In an embodiment, a UV lamp 81 connected to the circuit board 8 is arranged on a bottom of the middle housing 12. When the UV lamp 81 is turned on, ultraviolet rays are effectively irradiated on the water. And by using the ultraviolet rays emitted by the UV lamp 81, the pet drinking water can be further sterilized and disinfected, improving the water quality of pet drinking water.

In an embodiment, the main body surface housing 11 is provided with a functional operating part 123 electrically connected to the circuit board 8, and the circuit board 8 is configured to control working of the water pumping mechanism 3 or adjust driving pow of the electrolysis module 7 when a user operates the functional operating part 123. Specifically, the functional operating part 123 can be a touch key, a push switch, a DIP switch, etc. When the user operates the functional operating part 123, one or more of the water pumping mechanism 3, the electrolysis module 7, and the UV lamp 81 can be driven to turn on or off through the circuit board 8, so that the user can operate and use the pet drinking device 100 in the embodiment. Alternatively, when the user operates the functional operating part 123, the circuit board 8 adjusts the driving power of the electrolysis module 7. By adjusting the power of the electrolysis module 7, the concentration of ozone in electrolyzed water can be controlled. While meeting the disinfection and purification needs, the concentration of ozone in the water is adjusted to a value suitable for pets to drink, without causing pet health problems.

In an embodiment, a wireless module 9 configured to communicate with an external equipment is arranged in the mounting chamber 120, and the wireless module 9 is electrically connected to the circuit board 8. The device in the embodiment can realize wireless communication with external devices like mobile phones, tablets, and remote controls through the wireless module 9. This enables one or more of the water pumping mechanism 3, the electrolysis module 7, and the UV lamp 81 to be controlled to turn on or off through external devices such as mobile phones, tablets, and remote controls, improving the convenience of user use.

In an embodiment, a metal water basin 113 is arranged on the main body surface housing 11. The metal water basin 113 is fixed to the main body surface housing 11 when the main body surface housing 11 is injection molded. A bottom surface and a side wall of the metal water basin 113 are respectively a bottom surface and at least part of side wall of the drinking water trough 112. Specifically, using an inner side wall of the metal water basin 113 as part of the side wall of the drinking water trough 112 can facilitate subsequent cleaning.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A pet drinking device, comprising:
a water tank comprising a water storage chamber for storing water and a drinking water trough for pets to drink water;
a circuit board arranged on the water tank;
a water pumping mechanism electrically connected to the circuit board, the water pumping mechanism arranged on the water tank and configured to circulate water in the water storage chamber and the drinking water trough when being opened; and
an electrolysis module electrically connected to the circuit board, wherein when the electrolysis module is driven, the electrolysis module generates active substances for sterilization and disinfection, and the electrolysis module is configured to generate active substances for sterilization and disinfection during a circulation of water and when being driven.

2. The pet drinking device according to claim 1, wherein the water tank is provided with a drinking water outlet and a backwater channel respectively connected to the drinking water trough; the electrolysis module comprises an electrolysis housing with an electrolysis chamber, and an anode device and a cathode device arranged in the electrolysis chamber, the anode device and the cathode device are respectively electrically connected to the circuit board, the electrolysis housing is provided with an electrolysis water inlet and an electrolysis water outlet respectively connected to the electrolysis chamber, the electrolysis water outlet is connected to the drinking water outlet, each of two ends of the backwater channel is respectively connected to the drinking water trough and the water storage chamber, a water inlet of the water pumping mechanism is connected to the water storage chamber, and a water outlet of the water pumping mechanism is connected to the electrolysis water inlet.

3. The pet drinking device according to claim 2, wherein the electrolysis module further comprises an insulating member arranged in the electrolysis chamber, and the insulating member is positioned between the anode device and the cathode device.

4. The pet drinking device according to claim 2, wherein the electrolysis module further comprises a first conductive plate and a second conductive plate respectively electrically connected to the circuit board, one end of the first conductive plate is positioned in the electrolysis chamber and is electrically connected to the anode device, and one end of the second conductive plate is positioned in the electrolysis chamber and is electrically connected to the cathode device.

5. The pet drinking device according to claim 2, wherein the electrolysis housing comprises an electrolysis surface housing and an electrolysis bottom housing, the electrolysis chamber is formed by the electrolysis surface housing and the electrolysis bottom housing, and the electrolysis water inlet and the electrolysis water outlet are arranged on the electrolysis surface housing.

6. The pet drinking device according to claim 2, wherein the pet drinking device further comprises a filter element assembly arranged on the water tank, and the filter element assembly is configured to filter water during the circulation of water.

7. The pet drinking device according to claim 6, wherein the water tank is provided with a filter element housing on the backwater channel; the backwater channel comprises a water return port arranged on the water tank and positioned on a sidewall of the drinking water trough, at least three accommodating chambers communicating each other and arranged along the circulating water direction in the filter element housing, and a filter element water inlet and a filter element water outlet arranged on the filter element housing; the water return port is connected to the filter element water inlet, each of two sides of the filter element water inlet is respectively connected to the accommodating chamber and the backwater channel positioned on one side, and each of two sides of the filter element water outlet is respectively connected to the accommodating chamber and the water storage chamber positioned on the other side; the filter element assembly comprises a softened water quality filter element for softening water quality, a heavy metal filter element for filtering heavy metals and an antibacterial and deodorizing filter element for removing peculiar smell, and the antibacterial and deodorizing filter element, the softened water quality filter element, and the heavy metal filter element are respectively installed in one accommodating chamber.

8. The pet drinking device according to claim 7, wherein a height of a bottom surface of the accommodating chamber on one side adjacent to the filter element water inlet is higher than a height of the bottom surface of the accommodating chamber on one side adjacent to the filter element water outlet.

9. The pet drinking device according to claim 7, wherein the backwater channel further comprises a buffer channel arranged on a top of the filter element housing, each of two sides of the buffer channel is respectively connected to the water return port and the filter element water inlet, and the buffer channel is obliquely arranged downwards along the direction adjacent to the filter element water inlet.

10. The pet drinking device according to claim 7, wherein a partition plate is arranged between each two adjacent accommodating chambers of the at least three accommodating chambers, the backwater channel further comprises a first water passage arranged on the filter element housing, a first water passage opening arranged on a top of the partition plate close to one side of the filter element water inlet, and a second water passage opening arranged on a bottom of the partition plate close to one side the filter element water outlet; the buffer channel is connected to the filter element water inlet through the first water passage, the filter element water inlet is arranged close to a bottom of the accommodating chamber, the first water passage opening is connected to the filter element water inlet through the accommodating chamber, and the second water passage opening is connected to the filter element water outlet through the accommodating chamber.

11. The pet drinking device according to claim 10, wherein the backwater channel further comprises a second water passage arranged on the water tank, the second water passage is positioned on the filter element housing, and each of two sides of the second water passage is respectively connected to the buffer channel and the water return port.

12. The pet drinking device according to claim 10, wherein the filter element housing comprises a filter element surface housing and a filter element bottom housing, the filter element surface housing is connected to the filter element bottom housing form the accommodating chamber, the first water passage and the filter element water inlet,
the buffer channel is arranged on a top portion of the filter element surface housing, the partition plate is arranged on the filter element surface housing, and the filter element water outlet is arranged on the filter element bottom housing.

13. The pet drinking device according to claim 2, wherein a water flow trough is further arranged on a top portion of the water tank, the water flow trough is connected to the drinking water trough, a height of one end of the water flow trough connected to the drinking water trough is lower than a height of one end of the water flow trough far away from the drinking water trough, and the drinking water outlet is arranged on a bottom surface of the water flow trough and is positioned at the end of the water flow trough far away from the drinking water trough.

14. The pet drinking device according to claim 6, wherein the water tank comprises a main body bottom housing and an upper main body detachably connected to the main body bottom housing, the water storage chamber is formed by connecting the upper main body and the main body bottom housing, the drinking water outlet, the water return port, the water pumping mechanism, the filter element housing and the circuit board are arranged on the upper main body, and the filter element housing is detachably arranged on the upper main body.

15. The pet drinking device according to claim 14, wherein a storage groove for accommodating the filter element housing is provided at a bottom of the upper main body, a supporting block protrudes from a side wall of the upper main body corresponding to the storage groove, a butting block configured in cooperation with the supporting block is provided on the filter element housing, and the butting block is positioned above the supporting block when the filter element housing is placed in the storage groove.

16. The pet drinking device according to claim 14, wherein the upper main body is provided with a battery electrically connected to the circuit board, the battery is a rechargeable battery, the upper main body is provided with a charging interface for external connection of a power supply, and the charging interface is electrically connected to the circuit board.

17. The pet drinking device according to claim 16, wherein the upper main body comprises a middle housing and a main body surface housing connected to the middle housing to form a mounting chamber, the circuit board, the battery and the electrolysis module are arranged in the mounting chamber, the water storage chamber is formed by surrounding the middle housing and the main body bottom housing, and the main body bottom housing is detachably connected to the main body surface housing or the middle housing.

18. The pet drinking device according to claim 1, wherein the main body surface housing is provided with a functional operating part electrically connected to the circuit board, and the circuit board is configured to control working of the water pumping mechanism or adjust driving pow of the electrolysis module when a user operates the functional operating part.

19. The pet drinking device according to claim 1, wherein a wireless module configured to communicate with an external equipment is arranged in the mounting chamber, and the wireless module is electrically connected to the circuit board.

20. The pet drinking device according to claim 17, wherein a UV lamp connected to the circuit board is arranged on a bottom of the middle housing.
